(19) United States
(12) Patent Application Publication
(10) Pub. No.: US 2024/0426133 A1
(43) Pub. Date: Dec. 26, 2024

(54) Door Lock

(71) Applicant: Jeff Chen, Chiayi County (TW)

(72) Inventor: Jeff Chen, Chiayi County (TW)

(21) Appl. No.: 18/746,071

(22) Filed: Jun. 18, 2024

(30) Foreign Application Priority Data
Jun. 20, 2023 (TW) 112123149

(51) Int. Cl. E05B 9/08; E05B 63/00

(52) U.S. Cl. CPC E05B 9/08; E05B 63/0017

(57) ABSTRACT

A door lock has a lock latch, a first locking mechanism and a second locking mechanism. The first locking mechanism and the second locking mechanism can be relatively screwed and assembled with the lock latch. When the second locking mechanism is assembled relative to the first locking mechanism, the upper guide rail and the lower guide rails of the lower guide plate of the second locking mechanism are respectively embedded in the upper guide groove and the lower guide grooves of the first locking mechanism, and the internal thread portion of the second locking mechanism is relatively threaded with the external thread portion of the first locking mechanism. In addition, with the design of the internal thread portion and the external thread portion having the inner shaft moving surface and the outer shaft moving surface, respectively, the speed of threaded movement is faster when they are threaded together.

### BACKGROUND OF THE PRESENT INVENTION

### Field of Invention

The present invention relates to a door lock, and in particular, to a door lock that utilizes guide grooves and guide rails to guide each other to facilitate assembly.

### Description of Related Arts

Various types of door locks are available on the market, for example, door lock structures disclosed in Taiwan Patent Application Nos. 109112142 and 109215408, as well as U.S. Pat. No. 11,408,197 B2 and US 2022/0162883 A1, which are commonly used in household door locks. In order to achieve easy assembly, the number of assembly parts is often reduced, and structural changes are made to the parts. The present invention provides a design for mutual guidance of parts to facilitate the assembly of door locks.

### SUMMARY OF THE PRESENT INVENTION

Therefore, the purpose of the present invention is to provide a door lock that is easy to assemble.

Therefore, the door lock of the present invention is assembled on a door panel, which has a first board surface, a second board surface, a side edge, and an assembly hole penetrating the first board surface and the second board surface, wherein the door lock includes a lock latch, a first locking mechanism and a second locking mechanism; wherein the lock latch is assembled on the side edge of the door panel and extends into the assembly hole; wherein the first locking mechanism is assembled in the assembly hole from the first board surface of the door panel and properly assembled with the lock latch, and has an outer lock head, an upper arc piece and a lower arc piece, respectively, that extend from the outer lock head and are capable of being inserted into the assembly hole, and an external thread portion surrounding the outer edges of the upper arc piece and the lower arc piece, wherein the upper arc piece has an upper guide groove recessed on an inner arc surface thereof, and the lower arc piece has two parallel lower guide grooves recessed on an inner arc surface thereof, wherein the external thread portion includes a plurality of parallel external thread tracks formed, wherein each of the external thread tracks has an outer shaft moving surface and two outer guide moving surfaces extending diagonally from both sides of the outer shaft moving surface; and, wherein the second locking mechanism is assembled in the assembly hole from the second board surface of the door panel and properly connected with the lock latch, has a positioning cylinder and an outer seal cover, wherein the positioning cylinder is formed into a hollow shape, and has an internal thread portion formed on an inner edge thereof, wherein the internal thread portion is capable of being threaded relative to the external thread portion, and includes a plurality of parallel internal thread tracks formed, wherein each of the internal thread tracks has an inner shaft moving surface and two inner guide moving surfaces extending obliquely from both sides of the inner shaft moving surface, when the internal thread portion and the external thread portion are screwed to each other, the inner guide moving surfaces and the inner shaft moving surface are screwed to the outer guide moving surfaces and the outer shaft moving surface respectively, wherein the outer seal cover has an upper guide plate and a lower guide plate respectively formed into arc shapes, an upper guide rail protruding on the upper guide plate, and two parallel lower guide rails protruding on the lower guide plate, wherein the upper guide plate and the lower guide plate are capable of passing through the assembly hole, wherein the upper guide rail is embedded in the upper guide groove, and the lower guide rails are embedded in the lower guide grooves;

when the second locking mechanism is assembled relative to the first locking mechanism, the upper guide rail of the upper guide plate and the lower guide rails of the lower guide plate of the outer seal cover are respectively embedded in the upper guide groove and the lower guide grooves, and then the positioning cylinder is screwed relative to the outer lock head, so that the internal thread portion and the external thread portion are relatively screwed and tightened. In the aforementioned assembly process, by inserting the upper guide rail and the lower guide rails into the upper guide groove and the lower guide grooves respectively, the assembly of the first locking mechanism relative to the second locking mechanism is more convenient. In addition, with the design of the internal thread portion and the external thread portion having the inner shaft moving surface and the outer shaft moving surface, respectively, the speed of threaded movement is faster when they are threaded together, and the door lock has the effect of convenient assembly.

### BRIEF DESCRIPTION OF THE DRAWINGS

FIG. 1 is an exploded view of a door lock and door panel according to a preferred embodiment of the present invention.

FIG. 2 is a sectional view of a door lock assembly mounted on a door panel according to the preferred embodiment of the present invention.

FIG. 3 is an exploded view of the second locking mechanism of the door lock according to the preferred embodiment of the present invention.

FIG. 4 is a partial sectional view of the second locking mechanism of the door lock according to the preferred embodiment of the present invention.

FIG. 5 is an assembly action view of the door lock according to the preferred embodiment of the present invention.

FIG. 6 is another assembly action view of the door lock according to the preferred embodiment of the present invention.

### DETAILED DESCRIPTION OF THE PREFERRED EMBODIMENT

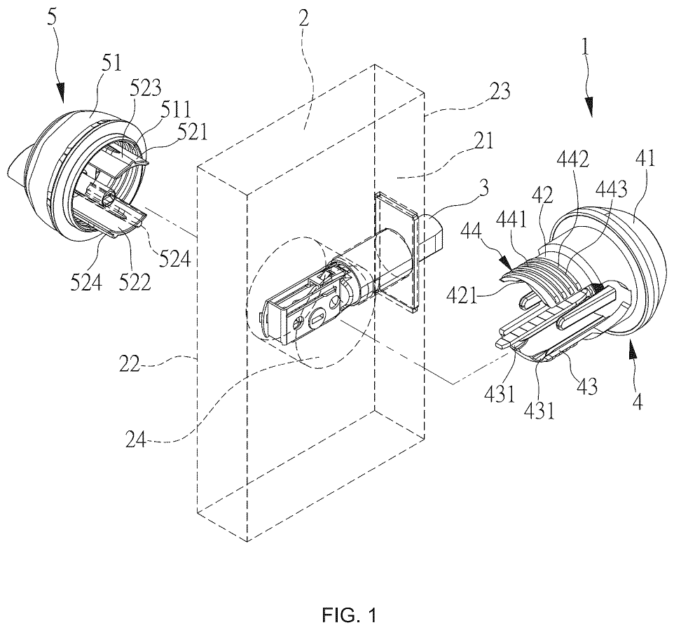

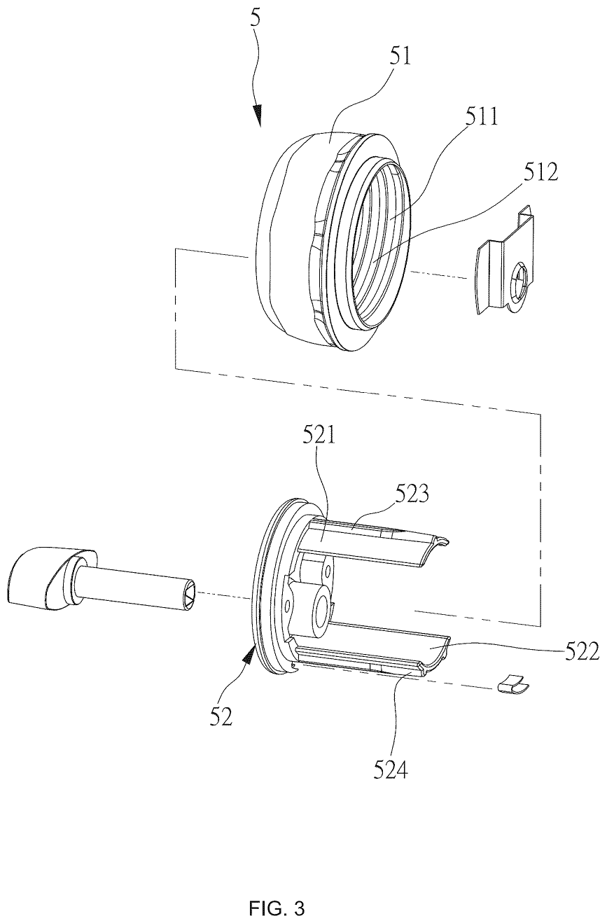

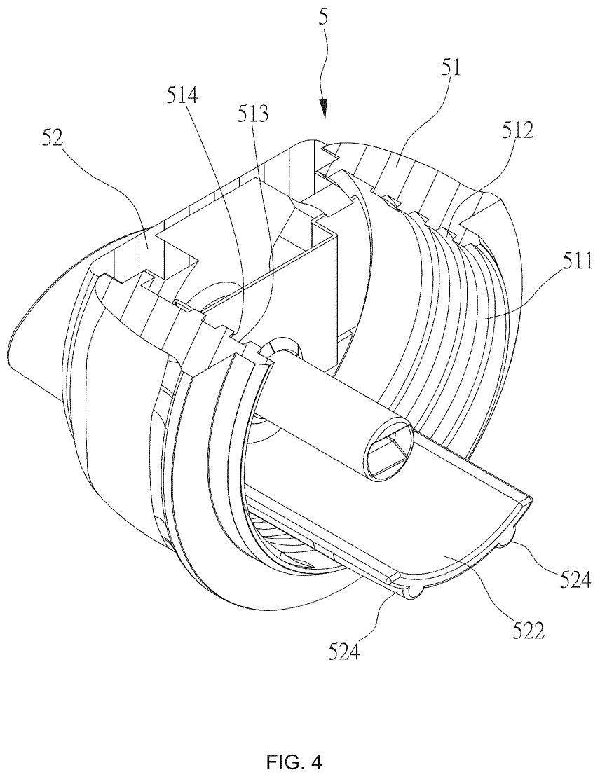

Referring to FIGS. 1-4, a preferred embodiment of the door lock 1 according to the present invention is installed on a door panel 2. The door panel 2 has a first board surface 21, a second board surface 22, a side edge 23, and an assembly hole 24 passing through the first board surface 21 and the second board surface 22. The door lock 1 includes a lock latch 3, a first locking mechanism 4, and a second locking mechanism 5 respectively arranged thereon, wherein the lock latch 3 is installed on the side edge 23 of the door panel 2 and extends into the assembly hole 24, wherein the first locking mechanism 4 and the second locking mechanism 5 are relatively coupled in the assembly hole 24, and are screwed to each other and properly assembled with the lock latch 3.

The first locking mechanism 4 is assembled in the assembly hole 24 from the first board surface 21 of the door panel 2, and has an outer lock head 41, an upper arc piece 42 and a lower arc piece 43, respectively, that extend from the outer lock head 41 and are capable of being inserted into the assembly hole 24, and an external thread portion 44 surrounding the outer edges of the upper arc piece 42 and the lower arc piece 43, wherein the upper arc piece 42 has an upper guide groove 421 recessed on an inner arc surface thereof, and the lower arc piece 43 has two parallel lower guide grooves 431 recessed on an inner arc surface thereof, wherein the external thread portion 44 includes a plurality of parallel external thread tracks 441 formed, wherein each of the external thread tracks 441 has an outer shaft moving surface 442 and two outer guide moving surfaces 443 extending diagonally from both sides of the outer shaft moving surface 442.

The second locking mechanism 5 is assembled in the assembly hole 24 from the second board surface 22 of the door panel 2, and has a positioning cylinder 51 and an outer seal cover 52, wherein the positioning cylinder 51 is formed into a hollow shape, and has an internal thread portion 511 formed on an inner edge thereof, wherein the internal thread portion 511 capable of being threaded relative to the external thread portion 44, and includes a plurality of parallel internal thread tracks 512 formed, wherein each of the internal thread tracks 512 has an inner shaft moving surface 513 and two inner guide moving surfaces 514 extending obliquely from both sides of the inner shaft moving surface 513, when the internal thread portion 511 and the external thread portion 44 are screwed to each other, the inner guide moving surfaces 514 and the inner shaft moving surface 513 are screwed to the outer guide moving surfaces 443 and the outer shaft moving surface 442 respectively, wherein the outer seal cover 52 has an upper guide plate 521 and a lower guide plate 522 respectively formed into arc shapes, an upper guide rail 523 protruding on the upper guide plate 521, and two parallel lower guide rails 524 protruding on the lower guide plate 522, wherein the upper guide plate 521 and the lower guide plate 522 are capable of passing through the assembly hole 24, wherein the upper guide rail 523 is embedded in the upper guide groove 421, and the lower guide rails 524 are embedded in the lower guide grooves 431.

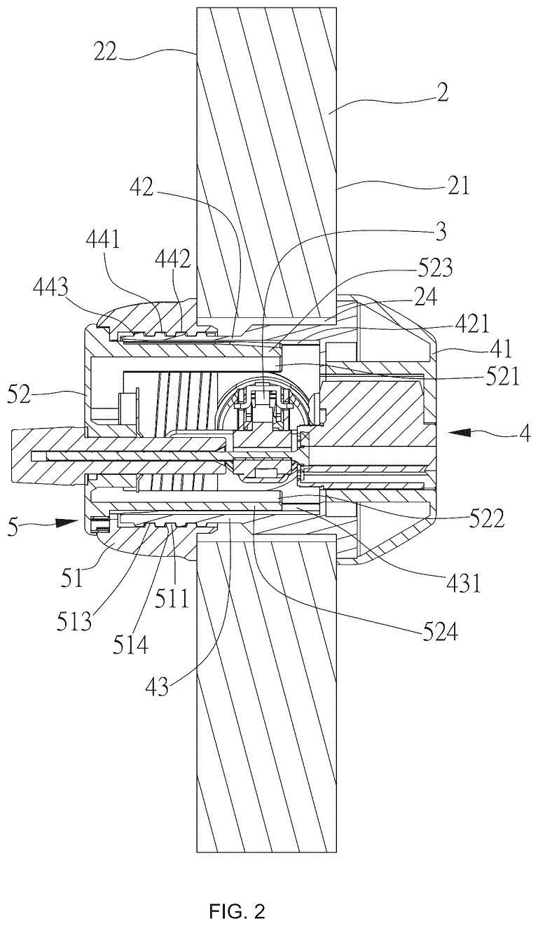

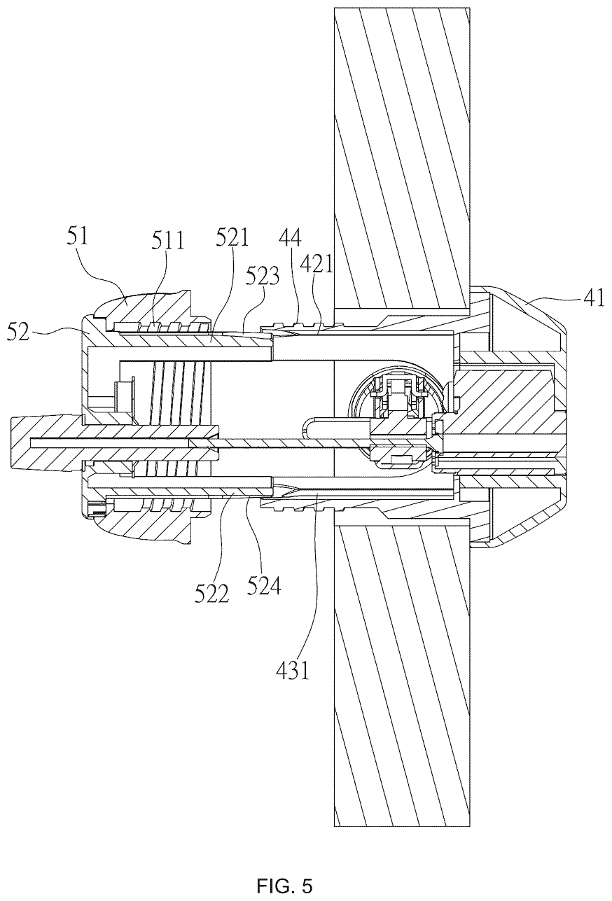

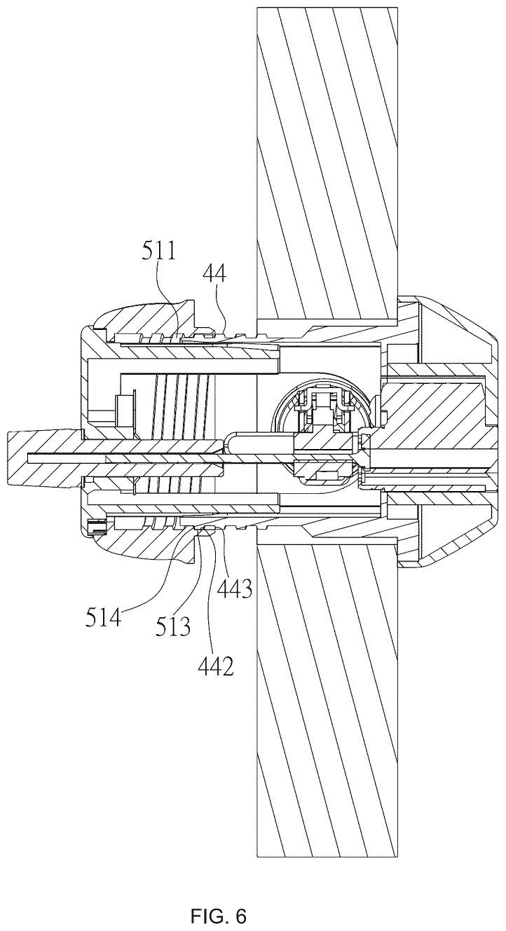

In the assembly process of the door lock 1 of the present invention, firstly, the lock latch 3 is installed in the assembly hole 24 from the side edge 23 of the door panel 2, and then the first locking mechanism 4 is also installed in the assembly hole 24 and properly assembled with the lock latch 3. At this time, the upper arc piece 42 and the lower arc piece 43 are inserted into the assembly hole 24. Next, the second locking mechanism 5 is assembled with the first locking mechanism 4, that is, as shown in FIG. 5, the upper guide rail 523 of the upper guide plate 521 and the lower guide rails 524 of the lower guide plate 522 of the outer seal cover 52 are respectively embedded in the upper guide groove 421 of the upper arc piece 42 and the lower guide grooves 431 of the lower arc piece 43, and then the positioning cylinder 51 is rotated after the internal thread portion 511 of the positioning cylinder 51 contacts the external thread portion 44 of the outer lock head 41, so that the inner threaded portion 511 and the outer threaded portion 44 are relatively threaded, as shown in FIG. 6. When threaded, the inner guide moving surfaces 514 of the internal thread tracks 512 and the outer guide moving surfaces 443 of the external thread tracks 441, as well as the inner shaft moving surface 513 and the outer shaft moving surface 442, are simultaneously screwed. Finally, as shown in FIG. 2, the positioning cylinder 51 is screwed tightly relative to the outer lock head 41, and the assembly of the door lock 1 is completed.

During the assembly process of the door lock 1, the upper guide rail 523 and the lower guide rails 524 are embedded into the upper guide groove 421 and the lower guide grooves 431 respectively, so that the first locking mechanism 4 is more convenient to assemble relative to the second locking mechanism 5. In addition, with the design of the internal thread portion 511 and the external thread portion 44 having the inner shaft moving surface 513 and the outer shaft moving surface 442, respectively, the speed of threaded movement is faster when they are threaded together, and the door lock 1 has the effect of convenient assembly.

What is claimed is:

1. A door lock, which is assembled on a door panel, wherein the door panel has a first board surface, a second board surface, a side edge, and an assembly hole that penetrate through the first board surface and the second board surface, wherein the door lock comprises:
a lock latch, which is assembled on the side edge of the door panel and extends into the assembly hole;
a first locking mechanism, which is assembled in the assembly hole from the first board surface of the door panel and properly assembled with the lock latch, and has an outer lock head, an upper arc piece and a lower arc piece, respectively, that extend from the outer lock head and are capable of being inserted into the assembly hole, and an external thread portion surrounding the outer edges of the upper arc piece and the lower arc piece, wherein the upper arc piece has an upper guide groove recessed on an inner arc surface thereof, and the lower arc piece has two parallel lower guide grooves recessed on an inner arc surface thereof, wherein the external thread portion includes a plurality of parallel external thread tracks formed, wherein each of the external thread tracks has an outer shaft moving surface and two outer guide moving surfaces extending diagonally from both sides of the outer shaft moving surface; and
a second locking mechanism, which is assembled in the assembly hole from the second board surface of the door panel and properly connected with the lock latch and screwed to the first locking mechanism, has a positioning cylinder and an outer seal cover, wherein the positioning cylinder is formed into a hollow shape, and has an internal thread portion formed on an inner edge thereof, wherein the internal thread portion is capable of being threaded relative to the external thread portion, and includes a plurality of parallel internal thread tracks formed, wherein each of the internal thread tracks has an inner shaft moving surface and two inner guide moving surfaces extending obliquely from both sides of the inner shaft moving surface, when the internal thread portion and the external thread portion are screwed to each other, the inner guide moving surfaces and the inner shaft moving surface are screwed to the outer guide moving surfaces and the outer shaft moving surface respectively, wherein the outer seal cover has an upper guide plate and a lower guide plate respectively formed into arc shapes, an upper guide rail protruding on the upper guide plate, and two parallel lower guide rails protruding on the lower guide plate, wherein the upper guide plate and the lower guide plate are capable of passing through the assembly hole, wherein the upper guide rail is embedded in the upper guide groove, and the lower guide rails are embedded in the lower guide grooves;
when the second locking mechanism is assembled relative to the first locking mechanism, the upper guide rail of the upper guide plate and the lower guide rails of the lower guide plate of the outer seal cover are respectively embedded in the upper guide groove and the lower guide grooves, and then the positioning cylinder is screwed relative to the outer lock head, so that the internal thread portion and the external thread portion are relatively screwed and tightened.
